(19) United States
(12) Patent Application Publication
(10) Pub. No.: US 2010/0309059 A1
(43) Pub. Date: Dec. 9, 2010

(54) Method and Apparatus of Positioning for a Wireless Communication System

(76) Inventors: Cheng-Hsuan Wu, Taipei City (TW); Chin-Tseng Huang, Hsinchu City (TW); Jiunn-Tsair Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/615,229

(22) Filed: Nov. 9, 2009

(30) Foreign Application Priority Data
Jun. 3, 2009 (TW) 098118371

(51) Int. Cl. G01S 5/02

(52) U.S. Cl. 342/463

(57) ABSTRACT

A method of estimating a position of a target device for a wireless communication system includes receiving a plurality of received signal strength measurements with respect to a plurality of base stations measured by the target device when the target device enters an area, and applying a graphical model to estimate the position of the target device according to the plurality of received signal strength measurements.

### BACKGROUND OF THE INVENTION

1. Field of the Invention

The present invention relates to a method and an apparatus of positioning for a wireless communication system, and more particularly, to a method and an apparatus applying a graphical model to estimate a position of a target device for a wireless communication system according to received signal strength measurements.

2. Description of the Prior Art

Position location (PL) techniques in wireless communication systems are crucial to many applications, emergency system, position-based billing services, the elderly and patients in special care, the target position of fire fighters and soldiers on missions, and etc. Time of Arrival (TOA), Angle of Arrival (AOA) and Received Signal Strength (RSS) are common position location techniques. Time of Arrival-based technique firstly calculates distances between each of three base stations and a target by propagation velocity multiplying propagation time of received signals estimated by the three base stations respectively, takes each of the three base stations as a center of a circle and each of the distances as a radius for drawing circles, and thereby gets the target position by a meeting point of the three circles. Angle of Arrival-based technique determines source directions of received signals estimated by two base stations respectively, takes each base station position as a start point for forming a straight line, and thereby gets the target position by a meeting point of the two straight lines. RSS-based technique utilizes received signal strength estimated by three base stations and pre-constructed signal transmission decay model for obtaining distances between each of the three base stations and the target respectively, takes each base station as a center of a circle and each of the distances as a radius for drawing circles, and thereby determines the target position. In the following description, a wireless communication system which performs position estimation is briefly called a position location system.

Since an indoor environment has complex furnishing and decoration, the radio signal propagation is not line of sight (or called Non-Line of Sight, NLOS) propagation, and a multipath effect is also quite obviously. The abovementioned TOA-based and AOA-based techniques are particularly affected by the multipath effect, and thereby easily cause errors during estimating the target position. On the other hand, variation of received signal strength is easy to estimate when the target moves, and thereby RSS-based technique are more suitable for indoor position location system than TOA-based and AOA-based techniques.

Indoor position location algorithms using RSS measurements can roughly be divided into two categories: pattern-recognition algorithm and model-based algorithm. In the pattern-recognition algorithm, the target position can be estimated according to received signal strength measurements estimated by the target and received signal strength measurements corresponding to multiple training points, such as RADAR and LANDMARC algorithms. The detailed content can be referred in a paper “RADAR: An in-building RF-based user location and tracking system” in Proc. IEEE INFOCOM 2000, vol. 2, March 2000 and “LANDMARC: Indoor location sensing using active RFID” in PerCom'03, March 2003. Please refer to FIG. 1, which is a schematic diagram of a wireless communication network 10 according to the prior art. The wireless communication network 10 includes a position location system 100, a target 102, and base stations AP₁-AP₄. In FIG. 1, an indoor environment of the base stations AP₁-AP₄ are defined as a testing area which is divided into multiple equal square training units, and four vertices of each of the training units respectively correspond to training points. When the target 102 has not entered the testing area, each base station performs offline training for obtaining RSS measurements corresponding to each training point position, and transmits those RSS measurements to a position database of the position location system 100. RSS measurements corresponding to the training points are assumed to be error-free. The target 102 reports the RSS measurements corresponding to each base station to the position location system 100 when the target 102 enters the testing area, and then the position location system 100 performs the RADAR or LANDMARC algorithm for extracting the position of the target 102 according to the received RSS measurements.

The RADAR algorithm obtains the position of the target 102 by averaging positions of k training points corresponding to k RSS measurements closest to the RSS measurements transmitted from the target 102 in the position database. However, measurement reliability of the averaged k training points may not be the same, which causes great error between a position result and an actual target position. The LANDMARC algorithm further distributes different weights to the positions of the k training points, and averages the weighted k training point positions for estimating the position of the target 102. The weight is a Euclidian distance between the RSS measurements transmitted from the target 102 and the RSS measurements corresponding to each of the k training points. However, the Euclidian distance of the received signal strength cannot reflect the geometric distance exactly. In addition, since the RADAR and LANDMARC algorithms do not take measurement errors of the received signal strength into account, the accuracy of position estimation is not improved significantly.

On the other hand, the model-based algorithms calculates distances between the target and the three base stations according to a pre-constructed radio propagation model and estimated received signal strength, and then uses a triangle algorithm to determine the target position. However, the model-based algorithms suffer the following disadvantages: (1) extensive channel measurements are needed to construct the radio propagation model and (2) a “good enough” position dependent RSS based radio propagation model in complex indoor environments is difficult to construct, and hence considerably affected the accuracy of position estimation. In addition to the abovementioned pattern-recognition and model-based algorithms, the indoor position location system can obtain the target position according to a maximum-likelihood algorithm. However, the maximum-likelihood algorithm is not feasible due to high computational complexity, and causes the indoor position location system overload. As can be seen, the abovementioned algorithms do not provides enough accuracy of position estimation.

### SUMMARY OF THE INVENTION

Therefore, the present invention provides a method and an apparatus of positioning for a wireless communication system, to position a target device accurately and lower the complexity of calculation simultaneously.

The present invention discloses a method of estimating a position of a target device for a wireless communication system. The method includes receiving a plurality of received signal strength measurements with respect to a plurality of base stations measured by the target device when the target device enters an area, and applying a graphical model to estimate the position of the target device according to the plurality of received signal strength measurements.

The present invention further discloses a device of a wireless communication system for executing the abovementioned method, for estimating a position of a target device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication network according to the prior art.

FIG. 2 is a flowchart of a process according to an embodiment of the present invention.

FIG. 3 is a power decay profile according to an embodiment of the present invention.

FIG. 4 is a factor graph according to an embodiment of the present invention.

FIG. 5A is a layout diagram of an indoor space which routers of a wireless local area network are located in.

FIGS. 5B, 5C, and 5D are power decay profiles corresponding to a router in FIG. 5A.

### DETAILED DESCRIPTION

The present invention utilizes a graphical model for estimating a position of a target device according to the soft information of the received signal strength measurements (namely Gaussian probability density functions which correspond to the received signal strength measurements).

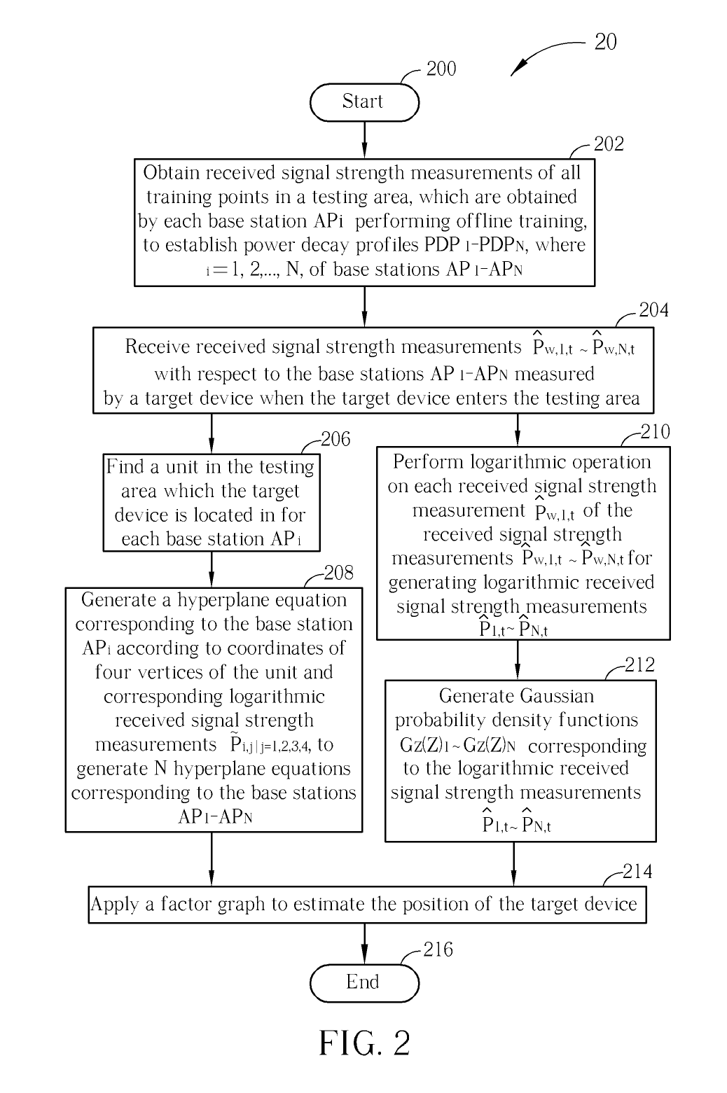

Please refer to FIG. 2, which is a flowchart of a process 20 according to an embodiment of the present invention. The process 20 is utilized in a position location system for positioning a target device. In the process 20, the position location system is set in an area which includes base stations AP₁-AP_{N} for detecting the target device entering the area and transmitting radio signal to the target device. Meanwhile, the position location system receives received signal strength measurements associated with the base stations AP₁-AP_{N} and the target device. The process 20 includes the following steps:

Step 200: Start.

Step 202: Obtain received signal strength measurements of all training points in a testing area, which are obtained by each base station APᵢ performing offline training, to establish power decay profiles PDP₁-PDP_{N}, where i=1, N, of base stations AP₁-AP_{N}.

Step 204: Receive received signal strength measurements \hat{p}_{w,1,t}-\hat{p}_{w,N,t} with respect to the base stations AP₁-AP_{N} measured by a target device when the target device enters the testing area.

Step 206: Find a unit in the testing area which the target device is located in for each base station APᵢ.

Step 208: Generate a hyperplane equation corresponding to the base station APᵢ according to coordinates of four vertices of the unit and corresponding logarithmic received signal strength measurements \tilde{p}_{i,j|j=1,2,3,4} \tilde{p}_{i,j|j=1,2,3,4}, to generate N hyperplane equations corresponding to the base stations AP₁-AP_{N}.

Step 210: Perform logarithmic operation on each received signal strength measurement \hat{p}_{w,i,t} of the received signal strength measurements \hat{p}_{w,1,t}-\hat{p}_{w,N,t} for generating logarithmic received signal strength measurements \hat{p}_{1,t}-\hat{p}_{N,t}.

Step 212: Generate Gaussian probability density functions G_{z}(z)₁-G_{z}(z)_{N} corresponding to the logarithmic received signal strength measurements \hat{p}_{1,t}-\hat{p}_{N,t}.

Step 214: Apply a factor graph to estimate the position of the target device.

Step 216: End.

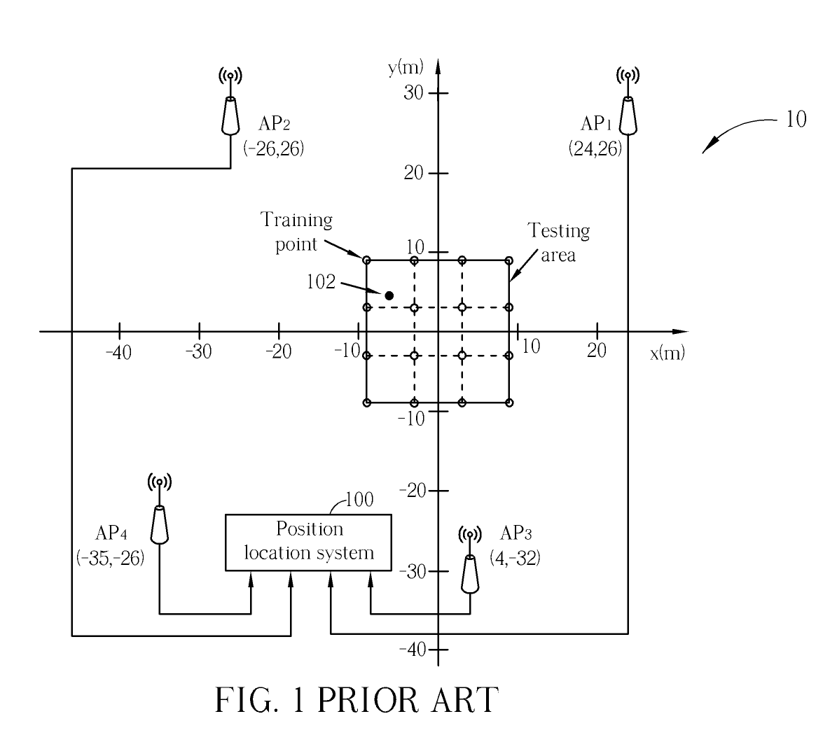

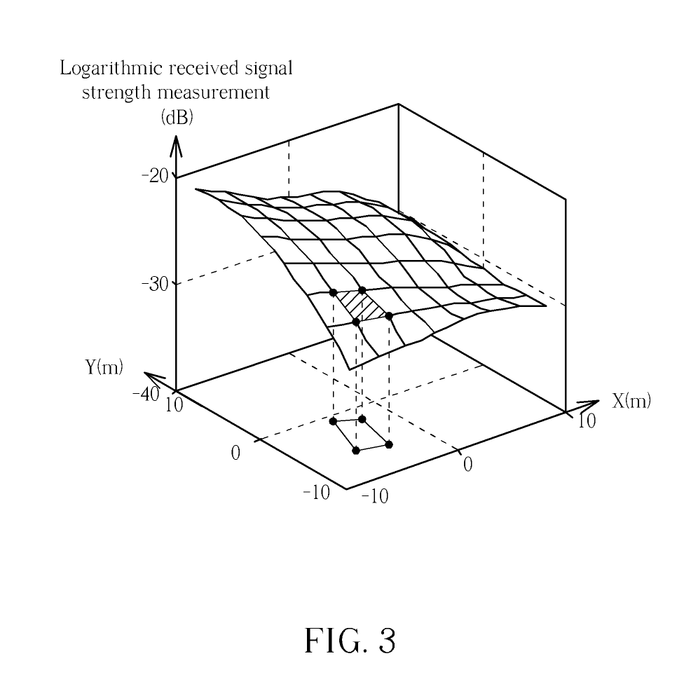

In the process 20, step 202 is performed by the position location system before the target device enters the testing area. Please refer to FIG. 1 for a related schematic diagram. The testing area is an area in which the position location system and the base stations AP₁-AP_{N} are located, and is divided into multiple equal square units, where four vertices of each unit correspond to training points. Before the target device enters the testing area, each base station APᵢ performs offline training for obtaining error-free received signal strength measurement \tilde{p}_{w,i,j} corresponding to a position of each training point (xⱼ, yⱼ), and transmits the error-free received signal strength measurement \tilde{p}_{w,i,j}, where j indicates a serial number of the training point, to a position database of the position location system. Therefore, for the position location system, the coordinate of each training point and the corresponding received signal strength measurement are known. According to step 202, the position location system establishes the power decay profile PDPᵢ of the base station APᵢ according to coordinate of each training point and multiple received signal strength measurements \tilde{p}_{w,i,j} obtained via offline training, and thereby establishes the power decay profiles PDP₁-PDP_{N} of the base stations AP₁-AP_{N}. Please refer to FIG. 3, which is a power decay profile according to an embodiment of the present invention. Each power decay profile is a continuous three-dimensional curve of a coordinating system (x, y, p), where (x, y) indicates position coordinate in the testing area, and p axis indicates the logarithmic received signal strength measurements. \tilde{p}_{1,j} indicates a logarithmic value of the received signal strength measurement \tilde{p}_{w,i,j} corresponding to the training points (xⱼ, yⱼ), and (xⱼ, yⱼ, \tilde{p}_{i,j}) is a point of the three-dimensional curve of the power decay profile PDPᵢ.

For simplifying the nonlinear relationship between the position coordinate in the power decay profile and the logarithmic received signal strength measurements, the present invention utilizes local linearization technique to simulate the power decay profile. In addition, as shown in FIG. 3, the three-dimensional curve of the power decay profile is regarded as a set of multiple unit curves. Coordinates (x, y) of four vertices of each unit curve is equivalent to four vertices of a unit in the testing area, namely the training points. The present invention supposes each unit curve approached to a three-dimensional plane which is called hyperplane. The hyperplane is expressed as:

aₓ·x+a_{y}·y+aₚ·p=c, (1)

where aₓ, a_{y}, and aₚ are coefficients of the hyperplane equation, c is a non-zero constant.

In a word, the hyperplane equation corresponding to the unit in which the target device is located is generated in step 204-208. The detailed description is as following. When the target device enters the testing area, the position location system receives received signal strength measurements \hat{p}_{w,1,t}-\hat{p}_{w,N,t} with respect to the base stations AP₁-AP_{N} measured by the target device. In a case of considering measurement error, the received signal strength measurement \hat{p}_{w,i,t} corresponding to the base station APᵢ is expressed as:

\hat{p}_{w,i,t}=\tilde{p}_{w,i,t}+nᵢ, (2)

where \hat{p}_{w,i,t} is a sum of error-free received signal strength measurement \hat{p}_{w,i,t} and a measurement error nᵢ which is a Gaussian probability density function.

Then, the position location system finds a unit Cᵢ in the testing area, where a sum of Euclidean Distance between the received signal strength measurement \tilde{p}_{w,i,j|j=1,2,3,4} corresponding to four vertices of the unit Cᵢ and the received signal strength measurement \hat{p}_{w,i,t} measured by the target device is the minimum. As can be seen from the above, the target device is located in the unit Cᵢ. Since coordinates of the training points and corresponding logarithmic received signal strength measurements can be known according to the established power decay profiles, simultaneous equations can be obtained:

a_{x,i}·xⱼ+a_{y,i}·yⱼ+a_{p,i}\tilde{p}_{i,j}=c, i=1, 2, . . . N, j=1,2,3,4, (3)

where (xⱼ, yⱼ) is a coordinate of the j^{th} training point, \tilde{p}_{i,j} is a logarithmic received signal strength measurement. Therefore, the coefficients a_{x,i}, a_{y,i}, and a_{p,i} can be obtained according to the equation (3), to generate a hyperplane equation:

a_{x,i}·x+a_{y,1}·y+a_{p,i}·p_{i,t}=c, (4)

where p_{i,t} indicates a variable of the received signal strength measurement measured by the target device, x, y indicate variables of the position of the target device. Similarly, the position location system utilizes the equation (3) for obtaining all plane equations corresponding to the base stations AP₁-AP_{N}.

In the process 20, step 210 to step 212 can be performed with the abovementioned step 206 to step 208. In step 210, the position location system respectively performs logarithmic operation on the received signal strength measurements \hat{p}_{w,1,t}-\hat{p}_{w,N,t} for generating logarithmic received signal strength measurements \hat{p}_{1,t}-\hat{p}_{N,t}. Each logarithmic received signal strength measurement \hat{p}ᵢₜ can be expressed as:

\hat{p}_{i,t}=10 log₁₀(\tilde{p}_{w,i,t}+nᵢ). (5)

According to equation (5), In the case of considering measurement error, a probability density function of the logarithmic received signal strength measurement \hat{p}_{i,t} is approached to a Gaussian probability density function. In step 212, the position location system further generates the corresponding Gaussian probability density functions G_{z}(z)₁-G_{z}(z)_{N} according to \hat{p}_{1,t}-\hat{p}_{N,t}.

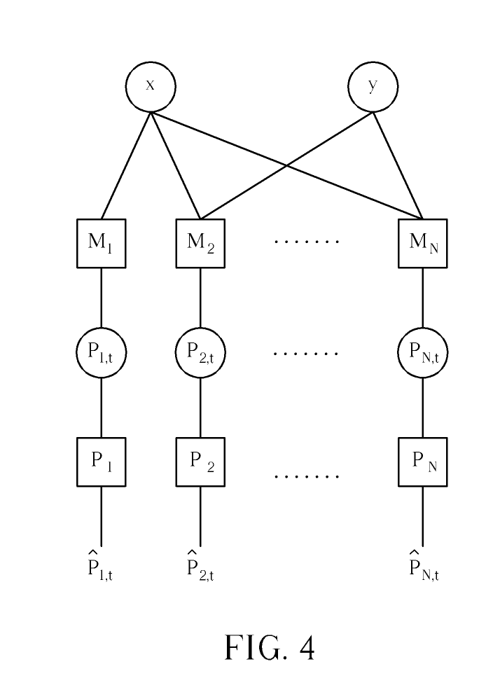

Finally, the present invention utilizes the factor graph to estimate the position of the target device. The factor graph is a kind of graphical model for processing relation between parameters and functions, to simplify position estimation and calculations during tracking. Please refer to FIG. 4, which is a factor graph according to an embodiment of the present invention. In FIG. 4, each function is indicated by a square which is called a constraint node or an agent node, for indicating a local constraint. Each parameter is indicated by a circle which is called a variable node. The factor graph in FIG. 4 includes two constraint nodes Pᵢ and Mᵢ, where Pᵢ indicates a function of generating the Gaussian probability density function G_{z}(z)ᵢ according to the logarithmic received signal strength measurement \hat{p}_{i,t}, and Mᵢ indicates the hyperplane equation of equation (4). As can be seen in FIG. 4, a variable node p_{i,t} is a Gaussian probability density function G_{z}(z)ᵢ, and all parameters in equation (4), including coordinates x, y, are soft information in a form of Gaussian probability density functions. Since those skilled in the art can obtain functions related to the soft information transmitted between the variable node and the constraint node according to the factor graph of FIG. 4, the detailed description is omitted herein. When a number of times of executing the factor graph reach a predetermined number, a mean value of probability density function of final coordinate x and a mean value of probability density function of coordinate y are coordinates of the target device estimated by the position location system.

Please note that, utilization of the factor graph for estimating the target device position is only an embodiment of the present invention. In other embodiments of the present invention, graphical models, such as normal graph or Tannar graph, is used for estimating the target device position. Both of the abovementioned graphical models are transformation of the factor graph. In a wireless communication network, base stations and positioned target device are defined according to different demands. For hardware implementation, the position location system can be installed independently, or installed on the side of the base station or the target device. For example, for a Global Position System, the base station is a satellite, the target device is a navigation device or a received antenna, and the position location system is usually installed in the target device. For a wireless local area network, the base station is a wireless network access point, the target is a wireless network card or a related network device, and the position location system is usually installed in the base station. For a radio frequency identification (RFID) system, a radio frequency identification reader is a base station, a radio frequency identification tag is a target device, and the position location system can be installed in the base station or installed independently. Please note that, the present invention can significantly improve inaccuracy of position estimation caused by multipath effect. Therefore, the present invention is more suitable utilized in the indoor position location system, but not limited in the indoor position location system.

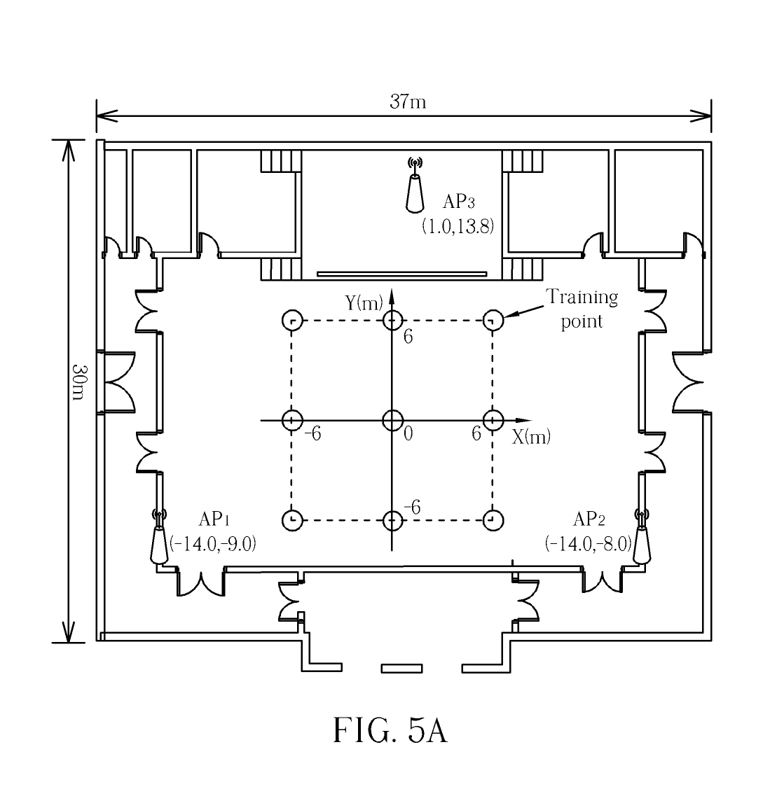

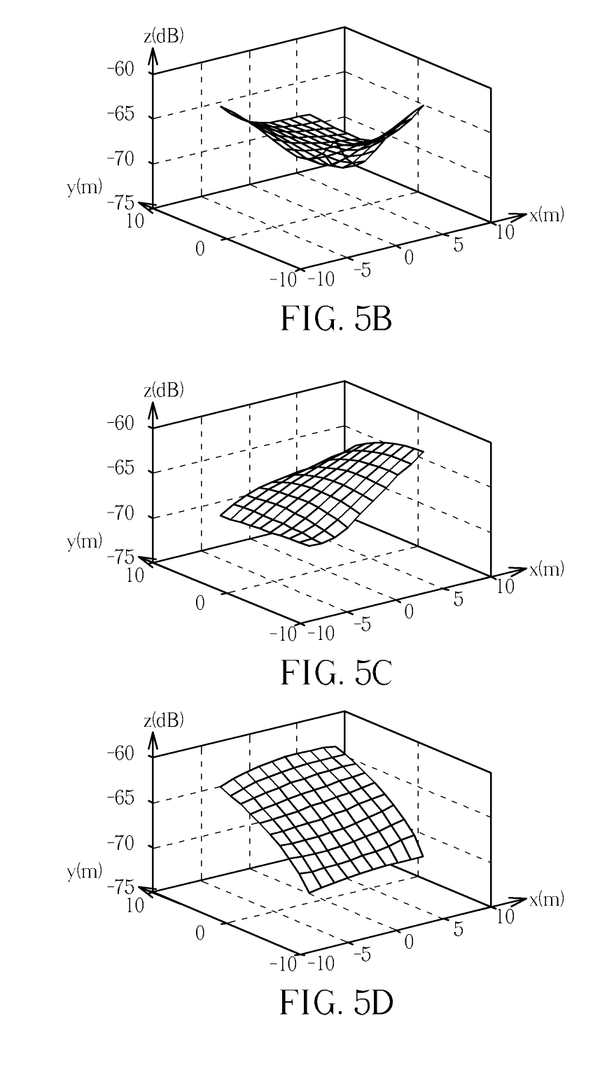

Please refer to FIG. 5A-5D. FIG. 5A is a layout diagram of an indoor space in which three routers AP₁-AP₃ of a wireless local area network are located. The routers AP₁-AP₃ are utilized for estimating a position of a wireless network card. FIGS. 5B, 5C, and 5D are power decay profiles corresponding to the routers AP₁-AP₃. In an environment shown in FIG. 5A-5D and in a condition of measurement error of the received signal strength measurements being 0.2483×10⁻⁸ watts, estimation accuracy is 1.01 m, 2.52 m, 1.42 m, 0.97 m by utilizing the process 20 of present invention, 4 Nearest Neighbor algorithm (which is similar to RADAR algorithm), LANDMARC algorithm, and maximum likehood algorithm, respectively. Estimation accuracy obtained by utilizing the process 20 is superior to 4 Nearest Neighbor algorithm and LANDMARC algorithm, and is closed to maximum likehood algorithm.

In conclusion, the present invention takes reliability of the received signal strength measurements into account, and estimates the target device position by using the factor graph according to the Gaussian probability density functions corresponding to the received signal strength measurements measured by the target device. The present invention significantly decreases the complexity of the position location system by a characteristic of the factor graph to simplify calculations, and enhances the accuracy of position estimation.

Those skilled in the art will readily observe that numerous modifications and alterations of the device and method may be made while retaining the teachings of the invention.

What is claimed is:

1. A method of estimating a position of a target device for a wireless communication system, the method comprising:
receiving a plurality of received signal strength measurements with respect to a plurality of base stations measured by the target device when the target device enters an area; and
applying a graphical model to estimate the position of the target device according to the plurality of received signal strength measurements.

2. The method of claim 1, wherein the graphical model comprises a plurality of constraint nodes for indicating a plurality of plane equations and a plurality of functions for generating a plurality of Gaussian probability density functions corresponding to the plurality of received signal strength measurements, each of the plurality of plane equations estimates the position of the target device according to one of the plurality of Gaussian probability density functions.

3. The method of claim 2 further comprising:
generating the plurality of plane equations according to the plurality of received signal strength measurements and a plurality of power decay profiles, each of the plurality of power decay profiles indicates a relation between a plurality of predetermined positions in the area and a plurality of error-free received signal strength measurements with respect to one of the plurality of base stations corresponding to the plurality of predetermined positions.

4. The method of claim 3, wherein a plane formed by each of the plurality of plane equations is approached to a part of a curve of one of the plurality of power decay profiles.

5. The method of claim 2, wherein the plurality of functions for generating the plurality of Gaussian probability density functions generates the plurality of Gaussian probability density functions according to a plurality of logarithmic received signal strength measurements.

6. The method of claim 1 further comprising:
establishing a plurality of power decay profiles according to a plurality of predetermined positions in the area and a plurality of error-free received signal strength measurements with respect to each of the plurality of base stations corresponding to the plurality of predetermined positions before the target device enters the area.

7. The method of claim 1, wherein the graphical model is a factor graph, or a transformation model of the factor graph.

8. A device of a wireless communication system for executing the method of claim 1, for estimating a position of a target device.
